(19) United States
(12) Patent Application Publication
(10) Pub. No.: US 2017/0109047 A1
(43) Pub. Date: Apr. 20, 2017

(54) DATA STORAGE DEVICE AND OPERATING METHOD THEREOF

(71) Applicant: SK hynix Inc., Gyeonggi-do (KR)

(72) Inventors: Su Jin LIM, Gyeonggi-do (KR); Chan Woo YANG, Gyeonggi-do (KR)

(21) Appl. No.: 15/056,786

(22) Filed: Feb. 29, 2016

(30) Foreign Application Priority Data
Oct. 16, 2015 (KR) 10-2015-0144482

(51) Int. Cl. G06F 3/06

(52) U.S. Cl. CPC G06F 3/064; G06F 3/0604; G06F 3/0637; G06F 3/0679

(57) ABSTRACT

A data storage device includes a controller; and a nonvolatile memory device including a plurality of memory blocks, and suitable for erasing a memory block selected from among the plurality of memory blocks, wherein the controller is suitable for managing the memory block through an erase prohibition list so that at least one predetermined erase cycle is ensured for the memory block.

### CROSS-REFERENCES TO RELATED APPLICATION

The present application claims priority under 35 U.S.C. §119(a) to Korean application number 10-2015-0144482, filed on Oct. 16, 2015, in the Korean Intellectual Property Office, which is incorporated herein by reference in its entirety.

### BACKGROUND)

1. Technical Field

Various embodiments of the disclosure relate generally to a data storage device and an operation method thereof.

2. Related Art

Generally, data storage devices may store data provided by an external device in response to a write request. Data storage devices may also provide stored data to an external device in response to a read request. External devices may include computers, digital cameras, cellular phones and the like. A data storage device can be embedded in an external device or fabricated separately and then connected afterwards to an external device.

### SUMMARY

Various embodiments of the disclosure are directed to a device and method for managing memory blocks of a data storage device.

In an embodiment of the disclosure, a data storage device may include: a controller; and a nonvolatile memory device including a plurality of memory blocks, and suitable for erasing a memory block selected from among the plurality of memory blocks, wherein the controller is suitable for managing the memory block through an erase prohibition list so that at least one predetermined erase cycle is ensured for the memory block.

In another embodiment of the disclosure, a method for operating a data storage device comprising a nonvolatile memory device comprising a plurality of memory blocks may include: selecting at least one of the plurality of memory blocks to be erased; and managing the selected at least one memory block through an erase prohibition list so that at least one predetermined erase cycle is ensured for the selected at least one memory block.

In still another embodiment of the disclosure, a data storage device may include: a nonvolatile memory device including a plurality of memory blocks; and a controller suitable for selecting at least one memory block to be erased based on a fast erasure prevention policy, and performing a block replacement operation for the selected at least one memory block.

### BRIEF DESCRIPTION OF THE DRAWINGS

FIG. 1 is a block diagram illustrating a data storage device, according to an embodiment of the invention.

FIG. 2 is a block diagram illustrating a nonvolatile memory device, according to an embodiment of the invention.

FIG. 3 is a diagram illustrating an example of an erase prohibition list, according to an embodiment of the invention.

FIGS. 4A and 4B are diagrams illustrating an example of selecting a memory block for a block replacement operation, according to an embodiment of the invention.

FIG. 5 is a flowchart illustrating an operation for managing an erase prohibition list, according to an embodiment of the invention.

FIG. 6 is a flowchart illustrating a block replacement operation, according to an embodiment of the invention.

FIG. 7 is a flowchart illustrating a block replacement operation, according to an embodiment of the invention.

FIG. 8 is a block diagram illustrating a solid state drive (SSD), according to an embodiment of the invention.

FIG. 9 is a block diagram illustrating a data processing system, according to an embodiment of the invention.

### DETAILED DESCRIPTION

Hereinafter, a data storage device and an operating method thereof according to the present invention will be described with reference to the accompanying drawings. The present invention may, however, be embodied in different forms and should not be construed as being limited to the embodiments set forth herein. Rather, these embodiments are provided to describe the present invention in detail to the extent that a person skilled in the art to which the invention pertains can practice the present invention.

It is to be understood that embodiments of the present invention are not limited to the particulars shown in the drawings, that the drawings are not necessarily to scale and, in some instances, proportions may have been exaggerated in order to more clearly depict certain features of the invention. While particular terminology is used, it is to be appreciated that the terminology used is for describing particular embodiments only and is not intended to limit the scope of the present invention.

Referring now to FIG. 1 a data storage device 10 according to an embodiment of the invention is provided. The data storage device 10 may be configured to store data provided from an external device (not shown), in response to a write request from the external device. Also, the data storage device 10 may be configured to provide stored data to the external device, in response to a read request from the external device.

The data storage device 10 may be configured as a personal computer memory card international association (PCMCIA) card, a compact flash (CF) card, a smart media card, a memory stick, a multimedia card (MMC), an embedded MMC (eMMC), a reduced-size multimedia card (RS-MMC) and a micro-size version of MMC (MMC-micro) a secure digital (SD) card, a mini secure digital (mini-SD) and a micro secure digital (micro-SD), a universal flash storage (UFS), or a solid state drive (SSD).

The data storage device 10 may include a controller 100 and a nonvolatile memory device 200.

The controller 100 may control the general operations of the data storage device 10. For example, the controller 100 may store data in the nonvolatile memory device 200 in response to a write request transmitted from the external device. The controller 200 may read data stored in the nonvolatile memory device 200 and output the read data to the external device in response to a read request transmitted from the external device. The controller 100 may perform various background operations for improving the operation performance of the data storage device 10, such as a garbage collection operation and a wear leveling operation.

The controller 100 may manage memory blocks through an erase prohibition list 110, based on a fast erasure prevention policy. For example, when a memory block is to be erased, the controller 100 may manage the memory block through the erase prohibition list 110 in such a manner that at least one predetermined erase cycle is ensured for the memory block. For example, so long as a memory block is included in the erase prohibition list 110, the memory block will be prohibited to be part of an erase operation. Accordingly, before a memory block is erased the memory block may be ensured with at least one predetermined erase cycle. The controller 100 may substantially prevent the certain memory block from being quickly degraded as the erase operation is iteratively performed for the certain memory block with a short interval, for example, an interval shorter than the predetermined erase cycle.

The controller 100 may perform a block replacement operation when performing a garbage collection operation, or a wear leveling operation, and the like. The controller 100 may perform a block replacement operation by copying valid data stored in a selected memory block, to another memory block, and then erasing the selected memory block.

Since a block replacement operation may be followed by an erase operation for a selected memory block, the controller 100 may select a memory block for which the block replacement operation is to be performed based on the fast erasure prevention policy. The controller 100 may select a memory block not included in the erase prohibition list 110 for the block replacement operation based on the erase prohibition list 110.

In an embodiment, the controller 100 may generate a candidate list 120 which includes candidate memory blocks, based on a predetermined block replacement policy, and may select a memory block for the block replacement operation, based on the candidate list 120 and the erase prohibition list 110. In another embodiment, the controller 100 may generate the candidate list 120 based on the predetermined block replacement policy and the erase prohibition list 110, and may select a memory block for the block replacement operation, based on the candidate list 120.

The controller 100 may store the erase prohibition list 110 and/or the candidate list 120 in a memory (not shown) comprised within the controller. Alternatively, the controller 100 may store the erase prohibition list 110 and/or the candidate list 120 in the nonvolatile memory device 200, and may use them by loading them on a memory within the controller.

The nonvolatile memory device 200 may include a flash memory device such as NAND flash or NOR flash, a ferroelectric random access memory (FeRAM), a phase-change random access memory (PCRAM), a magnetoresistive random access memory (MRAM), a resistive random access memory (ReRAM) and/or the like.

The nonvolatile memory device 200 may store data transmitted from the controller 100 under the control of the controller 100. The nonvolatile memory device 200 may read stored data and transmit read data to the controller 100, under the control of the controller 100.

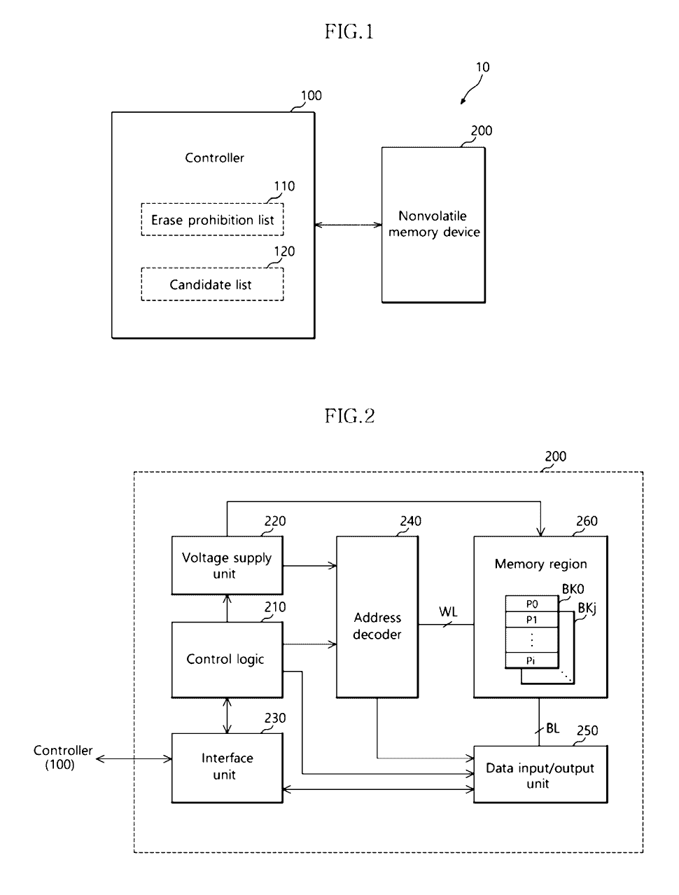

FIG. 2 is a block diagram illustrating a nonvolatile memory device, according to an embodiment of the invention. For example, the nonvolatile memory device of FIG. 2 may be the nonvolatile memory device 200 shown in FIG. 1.

The nonvolatile memory device 200 may include a control logic 210, a voltage supply unit 220, an interface unit 230, an address decoder 240, a data input/output unit 250, and a memory region 260.

The control logic 210 may control the general operations of the nonvolatile memory device 200 under the control of the controller 100 of FIG. 1. For example, the control logic 210 may receive a command from the controller 100 via the interface unit 230, and may transmit control signals to internal units of the nonvolatile memory device 200 in response to the received command.

The voltage supply unit 220 may generate various operation voltages for one or more of the general operations of the nonvolatile memory device 200, according to control of the control logic 210. For example, the voltage supply unit 220 may supply an erase voltage necessary for the erase operation, to a memory block selected in the memory region 260. The voltage supply unit 220 may, for example, supply various voltages to the address decoder 240 to be used in write and read operations.

The interface unit 230 may exchange various control signals including commands and addresses and data with the controller 100. The interface unit 230 may transmit various control signals and data inputted thereto, to the internal units of the nonvolatile memory device 200.

The address decoder 240 may decode addresses to select portions of the memory region 260 to be accessed in the memory region 260. For example, the address decoder 240 may selectively drive word lines WL and control the data input/output unit 250 to selectively drive bit lines BL, according to decoding results.

The data input/output unit 250 may transmit data transmitted from the interface unit 230, to the memory region 260 through the bit lines BL. The data input/output unit 250 may transmit data read from the memory region 260 through the bit lines BL, to the interface unit 230. The data input/output unit 250 may sense current formed in memory cells included in the memory region 260, and may acquire data corresponding to the memory cells, according to sensing results. The current may be as the memory cells included in the memory region 260 are turned on and off according to a read voltage.

The memory region 260 may be coupled with the address decoder 240 through the word lines WL, and may be coupled with the data input/output unit 250 through the bit lines BL. The memory region 260 may include a plurality of memory cells respectively disposed at areas where the word lines WL and the bit lines BL intersect each other for storing data The memory region 260 may include memory cell arrays of a two or three-dimensional structure.

The memory region 260 may include a plurality of memory blocks BK0 to BKj. Each of the memory blocks BK0 to BKj may include a plurality of pages P0 to Pi. A memory block may be a unit by which an erase operation is performed.

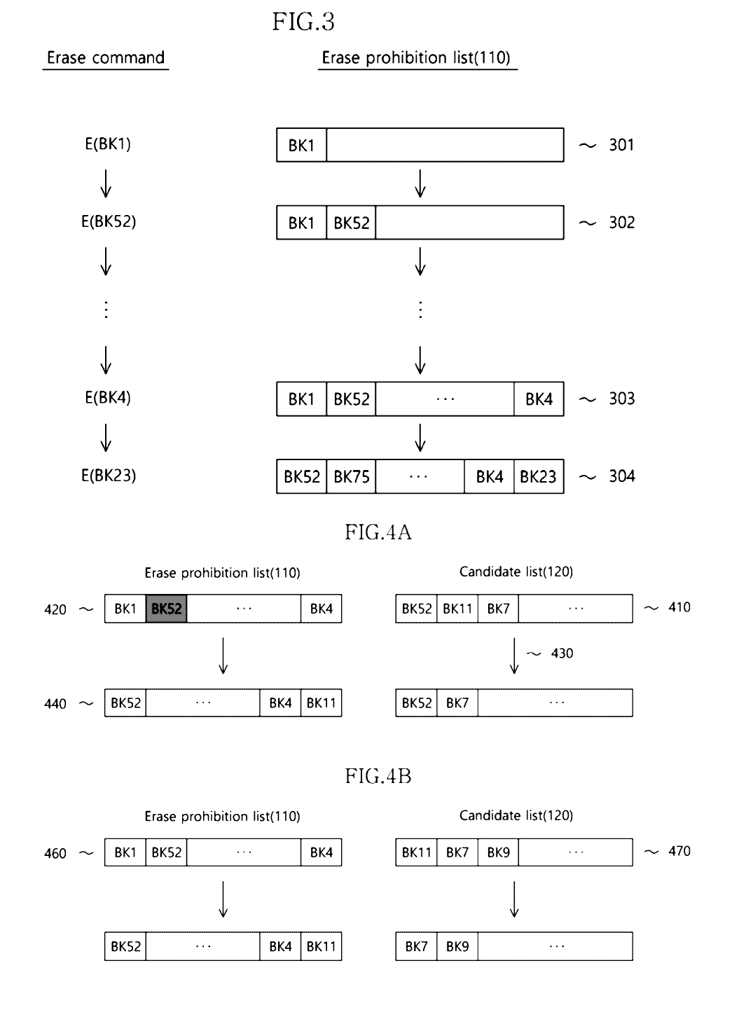

FIG. 3 is a diagram illustrating an example of an erase prohibition list according to an embodiment of the invention. For example, the erase prohibition list 110 of FIG. 3 may be managed by the controller 100 of FIG. 1.

When a memory block is erased, the controller 100 may add information regarding the memory block, to the erase prohibition list 110. The information regarding the memory block may be, for example, the address of the memory block. The controller 100 may delete information regarding a memory block, from the erase prohibition list 110 according to a first-in, first-out (FIFIO) scheme. In some embodiments, the controller 100 may delete information regarding a memory block from the erase prohibition list 110, after a predetermined erase prohibition time has elapsed from when the corresponding information is added to the erase prohibition list 110. In order to check whether the erase prohibition time for a particular block has elapsed, the controller 100 may manage information regarding a time when information regarding a memory block is added to the erase prohibition list 110. Regardless as to which scheme is adopted between the first-in first-out scheme, and the scheme of checking the elapse of the erase prohibition time, the controller 100 may manage memory blocks through the erase prohibition list 110 in such a manner that an at least predetermined erase cycle is ensured. For example, the controller 100 may manage memory blocks which are included in the erase prohibition list 110 in such a manner that an erase operation is prohibited for these memory blocks so long as they remain part of the erase prohibition list.

Referring to FIG. 3, for example, the controller 100 may control the nonvolatile memory device 200 to erase the memory block BK1. For example, the controller 100 may transmit an erase command E(BK1) to the nonvolatile memory device 200 specifying the memory block BK1 to be erased. The controller 100 may then add information regarding the memory block BK1, to the erase prohibition list 110 (301). Further, the controller 100 may transmit erase commands E(BK52), E(BK4) and E(BK23) to the nonvolatile memory device 200 to erase the memory blocks BK52, BK4 and BK23, and may add information regarding the memory blocks BK52, BK4 and BK23 to the erase prohibition list 110, respectively (302-304). When adding the information regarding the memory block BK23 to the erase prohibition list 110, if an empty area does not exist in the erase prohibition list 110, the controller 100 may generate an empty area for storing the information regarding the memory block BK23, by deleting the information on the memory block BK1 that is added earliest to the erase prohibition list 110. An erase operation for a memory block may be performed from when the information regarding the memory block is deleted from the erase prohibition list 110.

The total number of memory blocks capable of being simultaneously managed in the erase prohibition list 110 may vary. For example, the total number of memory blocks capable of being simultaneously managed in the erase prohibition list 110 may be set to be sufficient high to ensure an at least predetermined erase cycle according to a fast erasure prevention policy.

Memory blocks being managed in the erase prohibition list 110 may be prohibited to undergo an erase operation only, and may not be prohibited to undergo other operation such as a write and/or read operation.

FIGS. 4A and 4B are diagrams illustrating selecting a memory block for a block replacement operation according to an embodiment of the invention. For example, the memory block replacement operation of FIGS. 4A and 4B may be performed by the controller 100 of FIG. 1. The controller 100 may manage candidate memory blocks for which the block replacement operation is to be performed, as the candidate list 120, and may perform the block replacement operation for a memory block selected from the candidate list 120.

Referring to FIG. 4A, the controller 100 may generate the candidate list 120 based on one or more conditions, according to a predetermined block replacement policy. For example, the controller 100 may generate the candidate list 120 by designating memory blocks as candidate memory blocks, based on the number of valid pages included in the memory blocks or the erase counts of the memory blocks. The controller 100 may arrange candidate memory blocks in the candidate list 120, in an order of a higher block replacement efficiency. For example, the candidate memory blocks may be arranged in an order of an increasing number of valid pages starting with the memory block having the least number of valid pages. Or, also as an example, the candidate memory blocks may be arranged in an order of an increasing number of an erase count starting with the memory block having the least erase count number.

The controller 100 may select the memory block BK52 which is earliest in the candidate list 120, to perform the block replacement operation (410). The controller 100 may check whether the selected memory block BK52 is included in the erase prohibition list 110 (420). In the case where the selected memory block BK52 is included in the erase prohibition list 110, the controller 100 may select the next memory block BK11 in the candidate list 120 (430). The controller 100 may check whether the next selected memory block BK11 is included in the erase prohibition list 110. If, for example, the next selected memory block BK11 is not included in the erase prohibition list 110, the controller 100 may perform the block replacement operation for the selected memory block BK11. That is to say, when performing a block replacement operation, even though the memory block BK52 has the highest block replacement efficiency, the memory block BK52 is not selected while it is included in the erase prohibition list 110 so that an at least predetermined erase cycle is ensured. The memory block BK52 may be selected for the block replacement operation, after the information regarding the memory block BK52 is deleted from the erase prohibition list 110.

Information regarding the memory block BK11 for which the block replacement operation is performed may be added to the erase prohibition list 110 (440). When adding the information on the memory block BK11 to the erase prohibition list 110, if an empty area does not exist in the erase prohibition list 110, the controller 100 may delete the information on the memory block BK1 that is added earliest to the erase prohibition list 110.

Referring to FIG. 4B, the controller 100 may manage the candidate memory blocks included in the candidate list 120 so that they do not overlap with memory blocks included in the erase prohibition list 110. In other words, the controller 100 may generate the candidate list 120 by designating memory blocks not included in the erase prohibition list 110, as candidate memory blocks. For example, when generating the candidate list 120, the controller 100 may exclude the memory block BK52 included in the erase prohibition list 110, from being designated as a candidate memory block, by referring to the erase prohibition list 110 (460). Therefore, the controller 100 may sequentially select memory blocks from the earliest in the candidate list 120 to perform the block replacement operation, and may perform the block replacement operation for a selected memory block (470).

FIG. 4A shows the case where the candidate list 120 is generated by not reflecting the erase prohibition list 110, and FIG. 4B shows the case where the candidate list 120 is generated by reflecting the erase prohibition list 110 to prevent overlapping. In the case of FIG. 4A, the controller 100 may select a memory block for a block replacement operation, based on only the candidate list 120, in a situation where block replacement efficiency has a highest priority.

While FIGS. 4A and 4B show one candidate list 120, it is to be noted that the controller 100 may manage a plurality of candidate lists corresponding to various conditions. The controller 100 may select a memory block for the block replacement operation, based on any one selected from among a plurality of candidate lists arranged based on different conditions, by selecting a block replacement policy as the occasion demands.

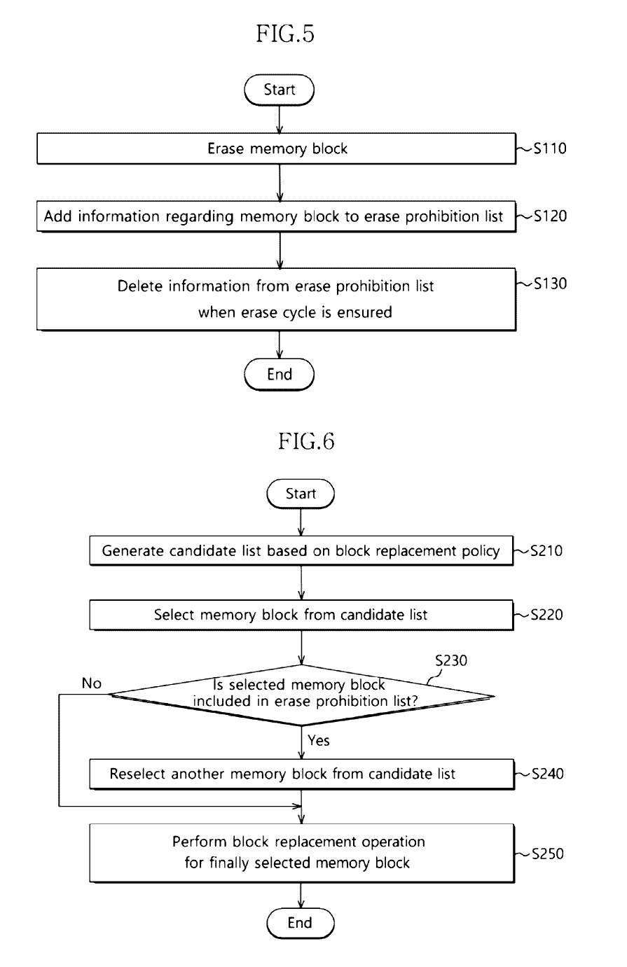

FIG. 5 is a flowchart illustrating an operation for managing an erase prohibition list, according to an embodiment of the invention. For example, operations in the flowchart of FIG. 5 may be performed by the controller 100 of FIG. 1.

Referring to FIG. 5, at step S110, the controller 100 may transmit an erase command to the nonvolatile memory device 200 to erase a memory block.

At step S120, the controller 100 may add information regarding the erased memory block, to the erase prohibition list 110. The controller 100 may use the memory block of which information is added to the erase prohibition list 110, for storing and reading data. However, the controller 100 may manage the memory block so that the erase operation is not performed for the memory block while the information regarding the memory block is included in the erase prohibition list 110.

At step S130, the controller 100 may delete the information regarding the memory block from the erase prohibition list 110, when an at least predetermined erase cycle is ensured for the memory block for which information is added to the erase prohibition list 110. For example, the controller 100 may delete the information from the erase prohibition list 110, according to a first-in first-out scheme. Or, also, as an example, the controller 100 may delete the information after a predetermined erase prohibition time elapses from the time when the corresponding information is added to the erase prohibition list 110.

FIG. 6 is a flowchart illustrating a block replacement operation, according to an embodiment of the invention. For example, operations in the flowchart of FIG. 6 may be performed by the controller 100 of FIG. 1.

Referring to FIG. 6, at step S210, the controller 100 may generate a candidate list such as the candidate list 120 described earlier as an example including candidate memory blocks, based on a predetermined block replacement policy. For example, the controller 100 may generate the candidate list 120 by designating memory blocks as candidate memory blocks, based on the numbers of valid pages included in memory blocks or the erase counts of the memory blocks.

At step S220, the controller 100 may select a memory block from the candidate list 120.

At step S230, the controller 100 may check whether the selected memory block is included in the erase prohibition list 110. In the case where the selected memory block is included in the erase prohibition list 110, the process may proceed to steps S240 and S250 in sequence. In the case where the selected memory block is not included in the erase prohibition list 110 the process may proceed to step S250 directly.

At step S240, the controller 100 may reselect another memory block from the candidate list 120.

At the step S250, the controller 100 may perform the block replacement operation for a finally selected memory block. The controller 100 may perform the block replacement operation by copying valid data stored in the finally selected memory block, to another memory block, and then erasing the finally selected memory block.

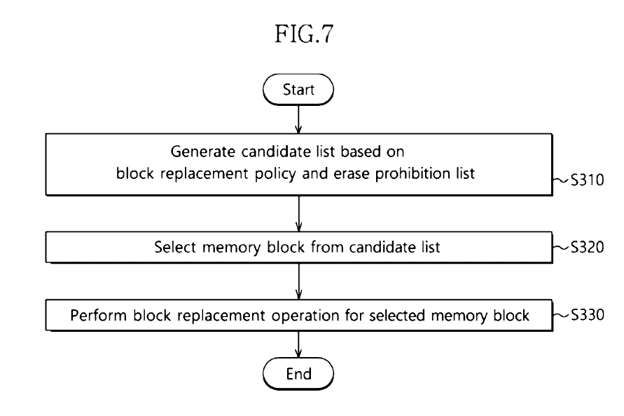

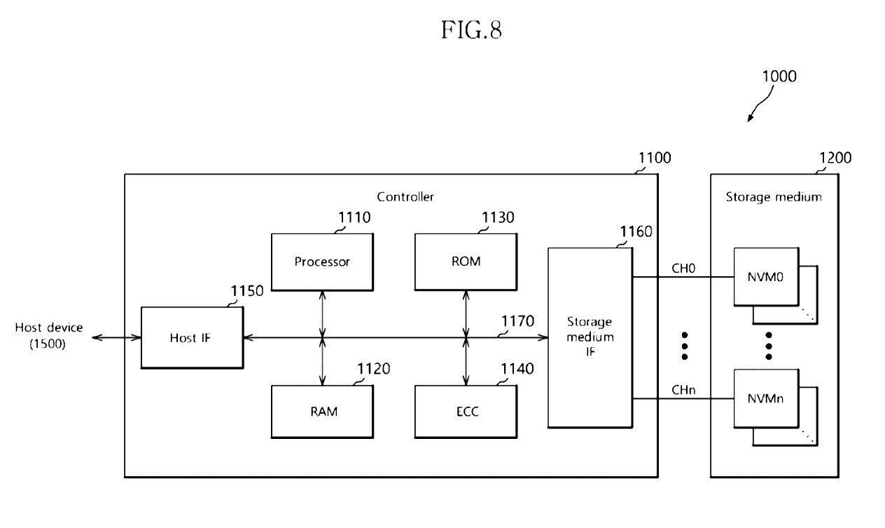

FIG. 7 is a flowchart illustrating a block replacement operation, according to another embodiment of the invention. For example, operations in the flowchart of FIG. 7 may be performed by the controller 100 of FIG. 1.

Referring to FIG. 7, at step S310, the controller 100 may generate the candidate list 120 including candidate memory blocks, based on the predetermined block replacement policy and the erase prohibition list 110. The controller 100 may generate the candidate list 120 such that candidate memory blocks included in the candidate list 120 do not overlap with memory blocks included in the erase prohibition list 110.

At step S320, the controller 100 may select a memory block from the candidate list 120.

At step S330, the controller 100 may perform the block replacement operation for the selected memory block.

Referring now to FIG. 8 a solid state drive (SSD) 1000, according to an embodiment of the invention, is provided. The SSD 1000 may include a controller 1100 and a storage medium 1200.

The controller 1100 may control data exchange between the host device 1500 and the storage medium 1200. The controller 1100 may include a processor 1110, a random access memory (RAM) 1120, a read only memory (ROM) 1130, an error correction code (ECC) unit 1140, a host interface 1150, and a storage medium interface 1160.

The controller 1100 may operate in a manner substantially similar to the controller 100 shown in FIG. 1. The controller 1100 may control memory blocks based on a fast erasure prevention policy so that at least one predetermined erase cycle is ensured for the memory blocks. The controller 1100 may select a memory block for a block replacement operation, based on a predetermined block replacement policy and a predetermined fast erasure prevention policy.

The processor 1110 may control the general operations of the controller 1100. The processor 1110 may store data in the storage medium 1200 and read stored data from the storage medium 1200, according to data processing requests from the host device 1500.

The RAM 1120 may store programs and program data to be used by the processor 1110. The RAM 1120 may temporarily store data transmitted from the host interface 1150 before transferring it to the storage medium 1200, and may temporarily store data transmitted from the storage medium 1200 before transferring it to the host device 1500.

The ROM 1130 may store program codes to be read by the processor 1110. The program codes may include commands to be processed by the processor 1110 for the processor 1110 to control the internal units of the controller 1100.

The ECC unit 1140 may encode data to be stored in the storage medium 1200, and may decode data read from the storage medium 1200. The ECC unit 1140 may detect and correct an error occurred in data, according to an ECC algorithm.

The host interface 1150 may exchange data processing requests, data, etc. with the host device 1500.

The storage medium interface 1160 may transmit control signals and data to the storage medium 1200. The storage medium interface 1160 may be transmitted with data from the storage medium 1200. The storage medium interface 1160 may be coupled with the storage medium 1200 through a plurality of channels CH0 to CHn.

The storage medium 1200 may include plurality nonvolatile memory devices NVM0 to NVMn. Each of the plurality of nonvolatile memory devices NVM0 to NVMn may perform a write operation and a read operation according to the control of the controller 1100.

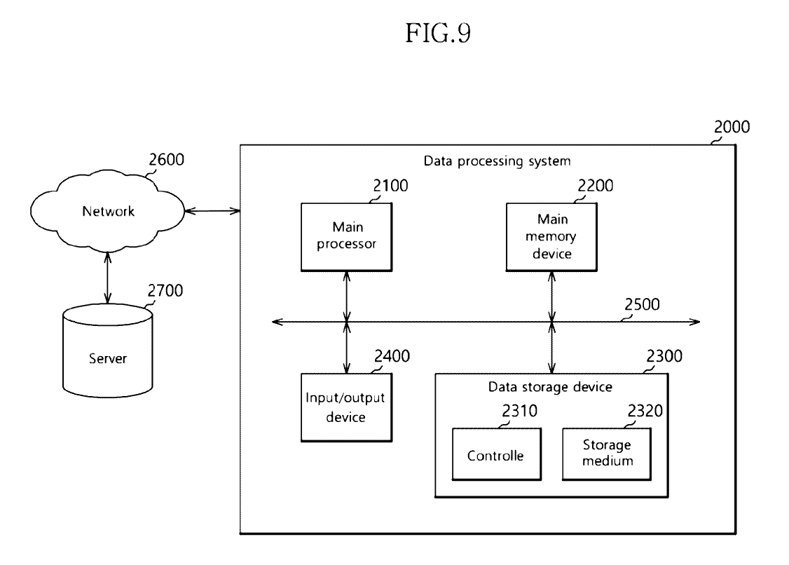

FIG. 9 is a block diagram illustrating a data processing system, according to an embodiment of the invention. For example, the data processing system 2000 of FIG. 9 may include a data storage device 2300 corresponding to the data storage device 10 of FIG. 1.

Referring to FIG. 9, the data processing system 2000 may include a computer, a laptop, a netbook, a smart phone, a digital TV, a digital camera, a navigator, etc. The data processing system 2000 may include a main processor 2100, a main memory device 2200, the data storage device 2300, and an input/output device 2400. The internal units of the data processing system 2000 may exchange data, control signals, etc. through a system bus 2500.

The main processor 2100 may control general operations of the data processing system 2000. The main processor 2100 may be, for example, a central processing unit such as a microprocessor. The main processor 2100 may execute the software of an operation system, an application, a device driver, and so forth, on the main memory device 2200.

The main memory device 2200 may store programs and program data to be used by the main processor 2100. The main memory device 2200 may temporarily store data to be transmitted to the data storage device 2300 and the input/output device 2400.

The data storage device 2300 may include a controller 2310 and a storage medium 2320. The data storage device 2300 may be configured and operate in a manner substantially similar to the data storage device 10 shown in FIG. 1.

The input/output device 2400 may include a keyboard, a scanner, a touch screen, a screen monitor, a printer, a mouse, or the like, capable of exchanging data with a user, such as receiving a command for controlling the data processing system 2000 from the user or providing a processed result to the user.

In some embodiments, the data processing system 2000 may communicate with at least one server 2700 through a network 2600 such as a local area network (LAN), a wide area network (WAN), a wireless network, and so on. The data processing system 2000 may include a network interface (not shown) to access the network 2600.

While various embodiments have been described above, it will be understood to those skilled in the art that the embodiments described are examples only. Accordingly, the data storage device and the operating method thereof described herein should not be limited based on the described embodiments. Various other embodiments and or variations of the present invention may be envisaged by those skilled in the art to which this invention pertains without departing from the spirit and/or scope of the present invention as defined by the appended claims.

What is claimed is:

1. A data storage device comprising:
a controller; and
a nonvolatile memory device including a plurality of memory blocks, the nonvolatile memory device being suitable for erasing a memory block selected from among the plurality of memory blocks,
wherein the controller is suitable for managing the memory block through an erase prohibition list so that at least one predetermined erase cycle is ensured for the memory block.

2. The data storage device according to claim 1, wherein the controller adds information regarding the memory block, to the erase prohibition list, when the memory block is erased, and deletes the information from the erase prohibition list.

3. The data storage device according to claim 1, wherein the controller deletes the information from the erase prohibition list according to a first-in first-out scheme.

4. The data storage device according to claim 1, wherein the controller adds information regarding the memory block, to the erase prohibition list, when the memory block is erased, and deletes the information from the erase prohibition list after a predetermined erase prohibition time has elapsed from a time when the information is added to the erase prohibition list.

5. The data storage device according to claim 1, wherein the controller selects a memory block from a candidate list including a plurality of candidate memory blocks, checks whether a selected memory block is included in the erase prohibition list, reselects another memory block from the candidate list depending on a checking result, and performs a block replacement operation for a finally selected memory block.

6. The data storage device according to claim 1,
wherein the controller selects a memory block from a candidate list including a plurality of candidate memory blocks, and performs a block replacement operation for a selected memory block.

7. The data storage device according to claim 6, wherein the candidate memory blocks do not overlap with memory blocks included in the erase prohibition list.

8. The data storage device according to claim 1, wherein the controller generates a candidate list including candidate memory blocks for which a block replacement operation is to be performed, based on at least one of the number of valid pages, an erase count and the erase prohibition list.

9. A method for operating a data storage device comprising a nonvolatile memory device comprising a plurality of memory blocks, the method comprising:
selecting at least one of the plurality of memory blocks to be erased; and
managing the selected at least one memory block through an erase prohibition list so that at least one predetermined erase cycle is ensured for the selected at least one memory block.

10. The method according to claim 9, wherein the managing step further comprises:
adding information regarding the selected at least one memory block to the erase prohibition list, when the selected at least one memory block is erased; and
deleting the added information from the erase prohibition list according to a scheme.

11. The method according to claim 10, wherein the scheme a first-in first-out scheme.

12. The method according to claim 10, wherein the scheme comprises deleting the added information after a predetermined erase prohibition time elapses from when the information is added to the erase prohibition list.

13. The method according to claim 9, wherein the selecting step comprises:
selecting the at least one memory block from a candidate list including a plurality of candidate memory blocks;
checking whether the selected at least one memory block is included in the erase prohibition list;
reselecting another memory block from the candidate list if the selected at least one memory block is included in the erase prohibition list; and
performing a block replacement operation for the reselected memory block.

14. The method according to claim 9, wherein the selecting step comprises:
selecting the at least one memory block from a candidate list including a plurality of candidate memory block, wherein the candidate memory blocks do not overlap with memory blocks included in the erase prohibition list.

15. The method according to claim 9 further comprising:
generating a candidate list including candidate memory blocks for which a block replacement operation is to be performed, based on at least one of the number of valid pages, an erase count and the erase prohibition list.

16. A data storage device comprising:
a nonvolatile memory device including a plurality of memory blocks; and
a controller suitable for selecting at least one memory block to be erased based on a fast erasure prevention policy, and performing a block replacement operation for the selected at least one memory block.

17. The data storage device according to claim 16, wherein the controller performs the block replacement operation by copying valid data stored in the selected memory block, to another memory block, and erasing the selected memory block.

18. The data storage device according to claim 16, wherein the controller adds information regarding the selected at least one memory block, to an erase prohibition list, based on the fast erasure prevention policy, and deletes the information from the erase prohibition list after at least one predetermined erase cycle is ensured.

19. The data storage device according to claim 18, wherein the controller selects a memory block not included in the erase prohibition list, to perform the block replacement operation.

20. The data storage device according to claim 18, wherein the controller generates a candidate list including candidate memory blocks for which the block replacement operation is to be performed, based on at least one of the number of valid pages, an erase count and the erase prohibition list.
